(19) United States
(12) Patent Application Publication
(10) Pub. No.: US 2025/0253394 A1
(43) Pub. Date: Aug. 7, 2025

(54) BI-POLAR ELECTRODE FOR SECONDARY METAL ION BATTERY CELL

(71) Applicant: GM GLOBAL TECHNOLOGY OPERATIONS LLC, DETROIT, MI (US)

(72) Inventor: SEUNG-WOO CHU, Sterling heights, MI (US)

(21) Appl. No.: 18/434,022

(22) Filed: Feb. 6, 2024

(51) Int. Cl. H01M 10/0565; B60L 50/64; H01M 4/02; H01M 4/13; H01M 4/62

(52) U.S. Cl. CPC H01M 10/0565; B60L 50/64; H01M 4/13; H01M 4/623; H01M 2004/029; H01M 2220/20; H01M 2300/0085

(57) ABSTRACT

Aspects of the disclosure include a bi-polar electrode design for secondary metal ion battery cells and methods of manufacturing the same. An exemplary vehicle includes an electric motor and a battery pack electrically coupled to the electric motor. The battery pack includes a battery cell that includes a bi-polar current collector, an anode coating layer formed on a first surface of the bi-polar current collector, and a cathode coating layer formed on a second surface of the bi-polar current collector. The battery cell further includes a roll-to-roll ionic channel blocker positioned along a first edge of the bi-polar current collector and a sheet-by-sheet ionic channel blocker positioned along a second edge and a third edge of the bi-polar current collector orthogonal to the first edge. The battery cell further includes an ionic conducting gel electrolyte formed over the anode coating layer and the cathode coating layer.

### INTRODUCTION

The present disclosure relates to battery cell manufacturing, and particularly to a bi-polar electrode design for secondary metal ion battery cells.

Electrodes are widely used in a range of devices that store electrical energy, including primary (non-rechargeable) battery cells, secondary (rechargeable) battery cells, fuel cells, and capacitors. An ideal electrode needs to balance various electrical energy storage characteristics, such as, for example, energy density, power density, maximum charging rate, internal leakage current, equivalent series resistance (ESR), charge-discharge cycle durability, high electrical conductivity, and low tortuosity. Electrodes often incorporate current collectors to supplement or otherwise improve upon these electrical energy storage characteristics. Current collectors can be added to provide a higher specific conductance and can increase the available contact area to minimize the interfacial contact resistance between the electrode and its terminal.

A current collector is typically a sheet of conductive material to which the active electrode material is attached. Aluminum foil, stainless steel, copper, and titanium foil are commonly used as the current collector of an electrode. In some electrode fabrication processes, for example, a film that includes activated carbon powder (i.e., the active electrode material) is attached to a thin aluminum foil using binding material or using an adhesive layer. To improve the quality of the interfacial bond between the film of active electrode material and the current collector, the combination of the film and the current collector is processed in a pressure laminator, for example, a calendering process or roll pressing. This process is generally known as calendering. Thus, the fabrication of an electrode typically involves the production of an active electrode material film (including, e.g., cathode and/or anode slurry preparation, the incorporation of any conductive additives and binding materials, the deposition of the slurry at a defined loading amount, and drying) and the lamination of that film onto a current collector.

### SUMMARY

In one exemplary embodiment a vehicle includes an electric motor and a battery pack electrically coupled to the electric motor. The battery pack includes a battery cell that includes a bi-polar current collector, an anode coating layer formed on a first surface of the bi-polar current collector, and a cathode coating layer formed on a second surface of the bi-polar current collector. The battery cell further includes a roll-to-roll ionic channel blocker positioned along a first edge of the bi-polar current collector and a sheet-by-sheet ionic channel blocker positioned along a second edge and a third edge of the bi-polar current collector orthogonal to the first edge. The battery cell further includes an ionic conducting gel electrolyte formed over the anode coating layer and the cathode coating layer.

In addition to one or more of the features described herein, in some embodiments, the roll-to-roll ionic channel blocker and the sheet-by-sheet ionic channel blocker include a metal ion channel blocker. In some embodiments, the metal ion channel blocker includes a non-ionic conducting gel having an infinite viscosity at zero shear rate.

In some embodiments, the non-ionic conducting gel is formed in-situ from a viscous solution that includes an organic solvent and a gelation polymer mixture that includes a cross-linkable polymer, a rheological modifier, and a cross-linking initiator.

In some embodiments, the metal ion channel blocker is formed in-situ and comprises a polyimide or polyimide blended with polyvinylidene difluoride (PVdF) polymer.

In some embodiments, the ionic conducting gel electrolyte is formed from a liquid electrolyte precursor that includes an organic solvent, a metal ion salt, a cross-linkable polymer, and a cross-linking initiator.

In some embodiments, the ionic conducting gel electrolyte is filled over the battery cell to a filling level that is between a topmost surface of the anode coating layer and a topmost surface of the cathode coating layer.

In another exemplary embodiment a battery cell includes a bi-polar current collector, an anode coating layer formed on a first surface of the bi-polar current collector, and a cathode coating layer formed on a second surface of the bi-polar current collector. The battery cell further includes a first ionic channel blocker positioned along a first edge of the bi-polar current collector, a second ionic channel blocker positioned along a second edge of the bi-polar current collector, and a third ionic channel blocker positioned along a third edge of the bi-polar current collector, the second edge and the third edge orthogonal to the first edge of the bi-polar current collector. The battery cell further includes an ionic conducting gel electrolyte formed over the anode coating layer and the cathode coating layer.

In some embodiments, the metal ion channel blocker includes a non-ionic conducting gel having an infinite viscosity at zero shear rate.

In some embodiments, the non-ionic conducting gel is formed from a viscous solution that includes an organic solvent and a gelation polymer mixture that includes a cross-linkable polymer, a rheological modifier, and a cross-linking initiator.

In some embodiments, the organic solvent includes a non-flammable organic solvent such as triethyl phosphate.

In some embodiments, the metal ion channel blocker is formed in-situ and includes a polyimide or polyimide blended with polyvinylidene difluoride (PVdF) polymer.

In some embodiments, the ionic conducting gel electrolyte is formed from a liquid electrolyte precursor that includes an organic solvent, a metal ion salt, a cross-linkable polymer, and a cross-linking initiator.

In some embodiments, the ionic conducting gel electrolyte is filled over the battery cell to a filling level that is between a topmost surface of the anode coating layer and a topmost surface of the cathode coating layer.

In yet another exemplary embodiment a method can include providing a bi-polar current collector, forming an anode coating layer on a first surface of the bi-polar current collector, forming a cathode coating layer on a second surface of the bi-polar current collector opposite the first surface of the bi-polar current collector, positioning a roll-to-roll ionic channel blocker along a first edge of the bi-polar current collector, positioning a sheet-by-sheet ionic channel blocker along a second edge and a third edge of the bi-polar current collector orthogonal to the first edge, and forming an ionic conducting gel electrolyte over the anode coating layer and the cathode coating layer.

In some embodiments, the metal ion channel blocker includes a non-ionic conducting gel having an infinite viscosity at zero shear rate.

In some embodiments, the non-ionic conducting gel is formed from a viscous solution that includes an organic solvent and a gelation polymer mixture that includes a cross-linkable polymer, a rheological modifier, and a cross-linking initiator.

In some embodiments, the organic solvent includes a non-flammable organic solvent such as triethyl phosphate.

In some embodiments, the metal ion channel blocker is formed in-situ and includes a polyimide or polyimide blended with PVdF polymer.

In some embodiments, the ionic conducting gel electrolyte is formed from a liquid electrolyte precursor that includes an organic solvent, a metal ion salt, a cross-linkable polymer, and a cross-linking initiator.

In some embodiments, the ionic conducting gel electrolyte is filled over the battery cell to a filling level that is between a topmost surface of the anode coating layer and a topmost surface of the cathode coating layer.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings.

FIG. 1 is a vehicle configured in accordance with one or more embodiments;

FIG. 2A is an example battery cell in accordance with one or more embodiments;

FIG. 2B is a detailed view of the battery cell shown in FIG. 2A in accordance with one or more embodiments;

FIG. 2C is a cross-sectional view of the battery cell taken along the line X-X′ in FIG. 2B in accordance with one or more embodiments;

FIG. 3 is an example view of an electrode of a battery cell during a first portion of a roll-to-roll manufacturing process in accordance with one or more embodiments;

FIG. 4 is an example view of an electrode of a battery cell during a second portion of a roll-to-roll manufacturing process in accordance with one or more embodiments;

FIG. 5 is an example view of an electrode of a battery cell during a third portion of a roll-to-roll manufacturing process in accordance with one or more embodiments; and

FIG. 6 is a flowchart in accordance with one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

Electrodes often incorporate current collectors to supplement or otherwise improve upon the electrical energy storage characteristics of a final integrated device (e.g., a battery). A current collector typically includes a sheet of conductive material (e.g., aluminum foil) to which an active electrode material is attached. An energy storage system such as a battery cell or pouch can include a number of stacked anode current collectors and cathode current collectors, an active material(s) dispersed or otherwise situated on the current collectors, and a sufficient number of separators to prevent shorts between the anode current collectors and cathode current collectors. Thus, in many electrode configurations there is a clear separation between anode and cathode, and each electrode serves a specific function, with electrons flowing from the anode to the cathode through an external circuit.

As the demand for energy storage systems offering higher energy densities, faster charging, and extended operational lifespans increases, driven in part by the proliferation of electric vehicles, significant challenges have been imposed on the materials used in battery cell components. Research and development efforts are continuously directed toward identifying novel materials and manufacturing techniques that can meet escalating demands on battery cells and other energy storage systems.

Bi-polar electrodes, in contrast to conventional single-polar electrodes, have the unique characteristic of serving as both an anode and a cathode within the same cell. This dual functionality eliminates the need for separate anode and cathode structures and streamlines the overall battery architecture. In a bi-polar electrode, the portion of the bi-polar electrode that functions as the anode contains anodic active materials that undergo electrochemical reactions during the discharge phase. The opposite side of the bi-polar electrode functions as the cathode and contains cathodic active materials that undergo electrochemical reactions during the charge phase.

Bi-polar electrode designs offer several advantages over single-polar electrodes, including increased energy densities (e.g., taking LFP-graphite battery cells near 250 Wh/kg and beyond 500 Wh/L), reduced mass for non-cell pack components (meaning relatively lower currents to deliver the same power), and less heat generation (meaning less cooling capability is required, e.g., improved DCFC).

Challenges remain, however, in designing and manufacturing bi-polar electrodes. Generally, bi-polar electrode designs require a solid electrolyte which is typically manufactured ex-situ (adding expense and integration complexity), meaning that the bi-polar electrodes themselves are often limited to batch style ex-situ manufacturing processes. Moreover, bi-polar electrodes are natively limited by a relatively (as compared to single-polar designs) high interfacial resistance between the electrodes and solid electrolyte. To mitigate these limitations, a liquid electrolyte can be introduced to minimize the interfacial resistance between the electrodes and solid electrolytes. Unfortunately, the additional bill of materials (BOM) required to support this process (e.g., the liquid electrolyte itself, blockers to prevent liquid electrolyte leakage, etc.) increases the complexity of bipolar electrode manufacturing and introduces new design constraints (e.g., liquid electrolyte leak, thin frame assembly in every bi-polar electrode sheet, etc.). Notably, this requires an additional current collector off-setting the gravimetric and/or volumetric energy density gain. In particular, assuming a single side coated cathode and anode electrode containing separator and electrolyte in the middle, the perimeters of prior bi-polar electrodes using a liquid electrolyte need to be wrapped.

This disclosure introduces a new bi-polar electrode and electrode assembly design for secondary metal ion battery cells and methods of manufacturing the same. Rather than relying on batch style ex-situ manufacturing processes and complicated BOM integrations, a continuous in-situ formation of a metal ion channel blocker on the cathode electrode coating edges is leveraged to provide a continuous bi-polar electrode manufacturing process with a streamlined, low-cost material. In some embodiments, an ionic channel blocker is applied roll-to-roll and sheet-by-sheet to at least one side edge of the cathode active coated layer in a continuous roll-to-roll manufacturing process. The ionic channel blocker can be formed roll-to-roll and sheet-by-sheet by dispensing a viscous solution that includes an organic solvent, a cross-linkable polymer, a rheological modifier, and a cross-linking initiator (e.g., a UV cross-linking initiator). The solution may have a modifier to provide a self-leveling characteristic, and subsequent heat and/or UV exposure can convert the solution to a non-ionic conducting gel-type ion channel blocker having an infinite viscosity at zero shear rate (that is, a non-ionic conducting gel). After completing the bi-polar electrode stack, the stack is wetted using a liquid electrolyte that includes an organic solvent (e.g., carbonate solvent, ether-based solvent, etc.), metal ion salt, cross-linkable polymer, and a cross-linking initiator. Cross-linking can be initiated in a similar manner as for the non-ionic conducting gel, except that the result is the formation of an ionic conducting gel electrolyte.

Leveraging a continuous in-situ metal ion channel blocker on the cathode electrode coating edges in accordance with one or more embodiments offers several technical advantages over prior electrode manufacturing techniques. Notably, the manufacturing process described herein can be used to continuously produce bi-polar electrodes without adding interfacial resistance between electrolytes, due in part to the conversion of the liquid non-ionic electrolyte via gelation. Moreover, the bi-polar electrode designs and manufacturing processes described herein are not limited to lithium chemistries, and can, for example, be readily applied to sodium (Na) ion battery cell designs to reduce the cost of Na ion battery cells.

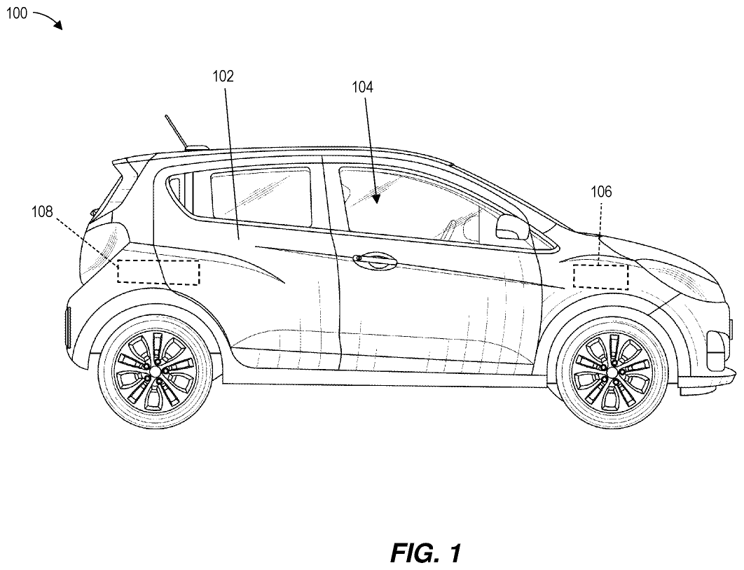

A vehicle, in accordance with an exemplary embodiment, is indicated generally at 100 in FIG. 1. Vehicle 100 is shown in the form of an automobile having a body 102. Body 102 includes a passenger compartment 104 within which are arranged a steering wheel, front seats, and rear passenger seats (not separately indicated). Within the body 102 are arranged a number of components, including, for example, an electric motor 106 (shown by projection under the front hood). The electric motor 106 is shown for ease of illustration and discussion only. It should be understood that the configuration, location, size, arrangement, etc., of the electric motor 106 is not meant to be particularly limited, and all such configurations (including multi-motor configurations) are within the contemplated scope of this disclosure.

The electric motor 106 is powered via a battery pack 108 (shown by projection near the rear of the vehicle 100). The battery pack 108 is shown for ease of illustration and discussion only. It should be understood that the configuration, location, size, arrangement, etc., of the battery pack 108 is not meant to be particularly limited, and all such configurations (including split configurations) are within the contemplated scope of this disclosure. Moreover, while the present disclosure is discussed primarily in the context of a battery pack 108 configured for the electric motor 106 of the vehicle 100, aspects described herein can be similarly incorporated within any system (vehicle, building, or otherwise) having an energy storage system(s) (e.g., one or more battery packs or modules), and all such configurations and applications are within the contemplated scope of this disclosure.

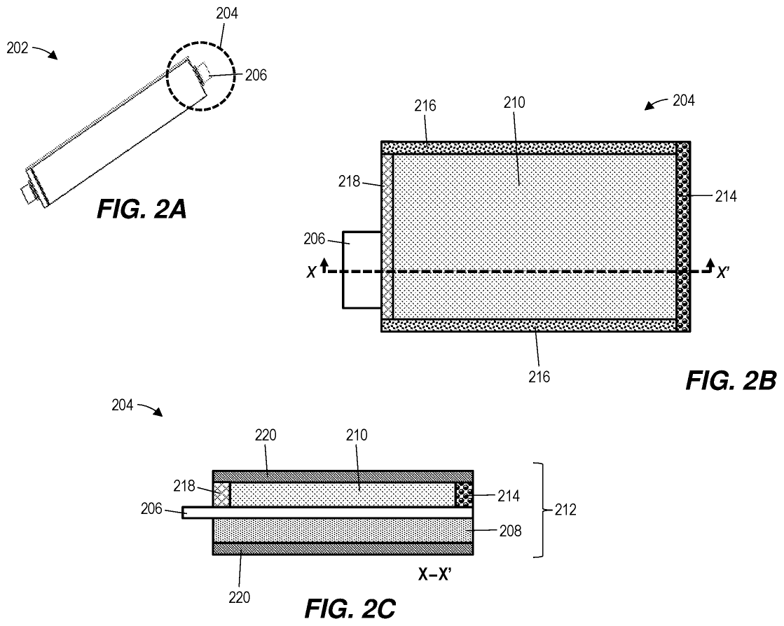

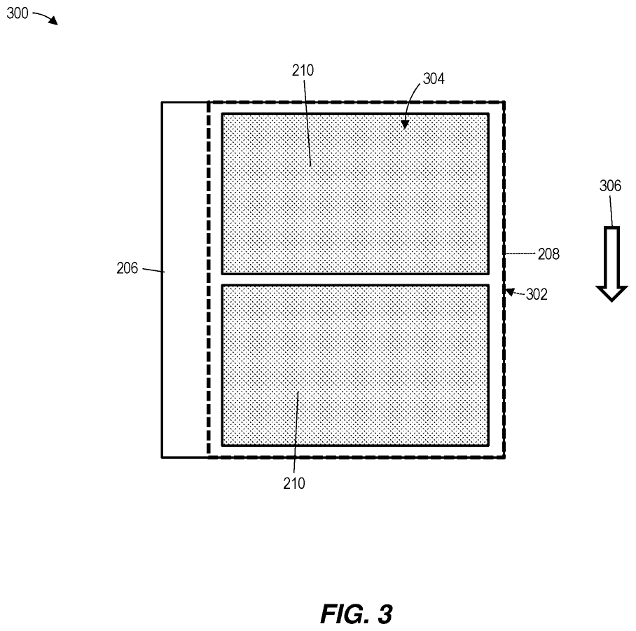

As will be detailed herein, the battery pack 108 includes one or more battery cells and/or battery pouches having a new bi-polar electrode design that includes an ionic channel blocker applied roll-to-roll and sheet-by-sheet to respective cathode active coated layers. An example electrode stack is shown in FIG. 2B. Example views of the bi-polar electrode over the course of an example roll-to-roll manufacturing process is shown in FIGS. 3-5.

FIG. 2A illustrates an example battery cell 202 in accordance with one or more embodiments. The battery cell 202 can be incorporated as one of a number of battery cells in a battery pack (e.g., the battery pack 108 in FIG. 1). FIG. 2B illustrates a detailed view 204 of the battery cell 202 shown in FIG. 2A in accordance with one or more embodiments. FIG. 2C illustrates a cross-sectional view of the battery cell 202 taken along the line X-X′ in FIG. 2B in accordance with one or more embodiments.

As shown in FIGS. 2B and 2C, the battery cell 202 includes one or more stacked bi-polar current collector(s) 206 (also referred to as shared current collectors). While only one bi-polar current collector 206 is shown for simplicity, it should be readily understood that the battery cell 202 can include any number of bi-polar current collectors (e.g., 2, 4, 10, 20, 100, etc.) and all such configurations are within the contemplated scope of this disclosure. The bi-polar current collector 206 includes an anode coating layer 208 and a cathode coating layer 210 (collectively defining, e.g., any number of coated bi-polar current collectors 212). The anode coating layer 208 and the cathode coating layer 210 can be formed on opposite surfaces of the bi-polar current collector 206.

The bi-polar current collector 206 can be made of sheets or foils of any suitable conductive material for bi-polar applications, such as, for example, stainless steel having a passive-state film formed on the surface thereof. The passive-state film on the stainless steel may consist of a layer of chromium (Cr) oxide on the so-called metal base side (the surface facing in towards the battery internals) and a layer of hydroxide(s) including iron (Fe) and Cr on the atmospheric side (the surface facing outwards). In some embodiments, the anode surface/side of the bi-polar current collector 206 (e.g., a graphite coated side) includes plated nickel to improve electrochemical stability. In other words, the bi-polar current collector 206 can include stainless steel having a plated nickel coating on one surface. Each layer thickness can be approximately 1 to 3 nm, although other thicknesses are within the contemplated scope of this disclosure. Without wishing to be bound by theory, it is understood that, in a normal environment, the higher the content of Cr (e.g., the Cr/(Cr+Fe) ratio) in the passive-state film, the higher the corrosion resistance is, and thereby the elution of metal ions decreases.

The anode coating layer 208 and the cathode coating layer 210 can include various cathode or anode active materials, respectively, such as, for example, activated carbon powder, nickel manganese cobalt oxide (NMC), lithium iron phosphate (LFP), nickel cobalt aluminum oxide (NCA), nickel cobalt manganese aluminum oxide (NCMA), lithium manganese iron phosphate (LMFP), lithium manganese rich (LMR), lithium manganese oxide (LMO), graphite, silicon, silicon-graphite composites, tin, tin oxide (SnO₂), lithium titanate (Li₄Ti₅O₁₂, LTO), and combinations thereof. In some embodiments, such as for sodium ion battery (SIB) applications, the cathode or anode active materials can include SIB active materials, such as layered- and tunnel-structured transition metal oxides, polyanion compounds, and prussian blue analogs (PBAs), hard carbon materials, such as petroleum coke or mesocarbon microbeads (MCMB), graphite, sodium titanates, such as Na₂Ti₃O₇ and Na_{0.44}MnO₂, tin-based compounds, such as SnO₂ and SnS₂, phosphorus-based compounds, such as phosphorus-carbon composites or phosphorus-based alloys, and combinations thereof.

The battery cell 202 further includes a roll-to-roll ionic channel blocker 214, a sheet-by-sheet ionic channel blocker 216, and an ionic conducting gel electrolyte 218, configured and arranged as shown. Manufacturing and placement of the roll-to-roll ionic channel blocker 214, the sheet-by-sheet ionic channel blocker 216, and the ionic conducting gel electrolyte 218 is discussed in greater detail with respect to FIGS. 3-5.

The battery cell 202 can further include one or more separators 220. The separators 220 can be positioned to isolate each respective one of the one or more coated bi-polar current collectors 212. Note that for clarity the separators 220 are omitted from the view shown in FIG. 2B. The separators 212 can include dielectric materials such as, for example, polyethylene (PE), polypropylene (PP), polyethylene terephthalate (PET), and composites thereof, although other dielectrics are within the contemplated scope of this disclosure. In some embodiments, the separators 212 may include a thermally stable coating layer to improve shrinkage behavior (e.g., a porous ceramic coating or porous ester type polymer coating including, for example, polyimde, polyamide, polyimide-polyamide (PI/PA) copolymer, etc.).

FIG. 3 illustrates an example view of an electrode 300 of a battery cell (e.g., the battery cell 202 of FIGS. 2A, 2B, and 2C) during a first portion of a roll-to-roll manufacturing process (not separately shown) in accordance with one or more embodiments. In some embodiments, the electrode 300 includes a bi-polar current collector 206. In some embodiments, an anode coating layer 208 is formed on a first surface 302 of the bi-polar current collector 206 (shown via projection only). In some embodiments, the anode coating layer 208 is formed continuously during the roll-to-roll manufacturing process. In some embodiments, a cathode coating layer 210 is formed on a second surface 304 opposite the first surface 302 of the bi-polar current collector 206. In some embodiments, a number of cathode coating layers 210 are formed intermittently during the roll-to-roll manufacturing process. In some embodiments, the electrode 300 is directed along the roll-to-roll manufacturing process via one or more rollers (e.g., pull rollers, positioning, rollers, etc., not separately shown) in a direction 306 (indicated by a stylized arrow in the relatively north to south direction in the orientation shown).

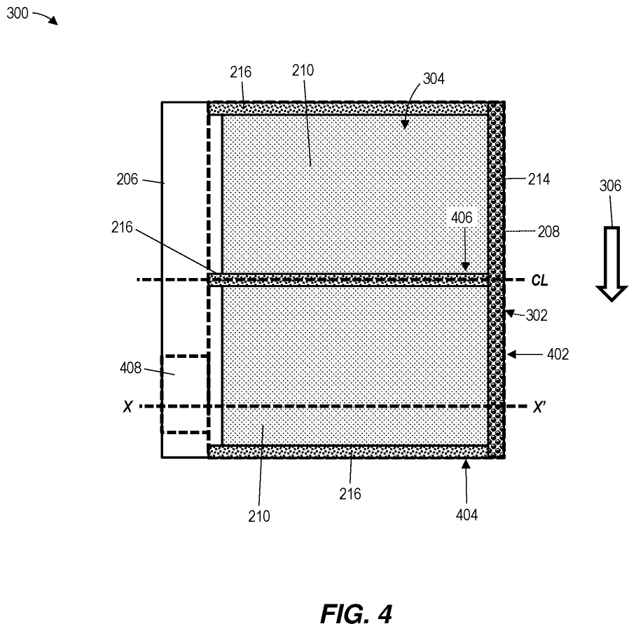

FIG. 4 illustrates an example view of the electrode 300 during a second portion of a roll-to-roll manufacturing process (not separately shown) in accordance with one or more embodiments. In some embodiments, a roll-to-roll ionic channel blocker 214 is dispensed onto the second surface 304 of the bi-polar current collector 206 at a first edge 402 (also referred to as a first cathode electrode coating edge) of the bi-polar current collector 206. In some embodiments, roll-to-roll ionic channel blocker 214 is dispensed continuously as the electrode 300 is pulled or otherwise passed along the direction 306. In some embodiments, the first edge 402 is formed parallel to the direction 306. In some embodiments, the roll-to-roll ionic channel blocker 214 is a metal ion channel blocker.

The roll-to-roll ionic channel blocker 214 can be formed from a viscous solution which is dispensed over the first edge 402 of the bi-polar current collector 206. In some embodiments, the viscous solution can include an organic solvent and a gelation polymer mixture that includes a cross-linkable polymer, a rheological modifier, and a cross-linking initiator. The viscous solution can be polymerized using, for example, a UV exposure and/or heat, which initiates a cross-linking of the cross-linkable polymer. The result is a phase transition from an initial liquid form to a gel form having infinite viscosity at a zero shear rate.

Alternatively, or in addition, the roll-to-roll ionic channel blocker 214 can be formed in-situ and can include a polyimide or a polyimide blended with a polymer (e.g., polyvinylidene difluoride polymer) that is dispensed over the first edge 402 of the bi-polar current collector 206. In some embodiments, the fully-imidized polymide-polymer blend is dried using, for example, a heater (an infrared heater, in-line oven, air heater, etc.) and/or dedicated venting system (not separately shown) for solvent recovery. In some embodiments, such as those using a fully imidized polyimide solution as a channel blocker, the polyimide can be applied in a dissolved form in a processing solvent (e.g., NMP).

As further shown in FIG. 4, in some embodiments a sheet-by-sheet ionic channel blocker 216 is dispensed onto the second surface 304 of the bi-polar current collector 206. In some embodiments, the sheet-by-sheet ionic channel blocker 216 is dispensed on a second edge 404 and a third edge 406 opposite the second edge 404. In some embodiments, the second edge 404 and the third edge 406 are orthogonal to the first edge 402 and the direction 306 (as shown). In some embodiments, the sheet-by-sheet ionic channel blocker 216 is dispensed intermittently as the electrode 300 is pulled or otherwise passed along the direction 306. In some embodiments, the sheet-by-sheet ionic channel blocker 216 is dispensed from the first edge 402 and along the respective second edge 404 or third edge 406. In some embodiments, the sheet-by-sheet ionic channel blocker 216 is positioned to cover the underlying anode coating layer 208 (as shown). In some embodiments, the sheet-by-sheet ionic channel blocker 216 is a metal ion channel blocker. The sheet-by-sheet ionic channel blocker 216 can be formed of similar materials and in a similar manner as previously described with respect to the roll-to-roll ionic channel blocker 214.

In some embodiments, the electrode 300 is trimmed for packaging following the formation of the roll-to-roll ionic channel blocker 214 and the sheet-by-sheet ionic channel blocker 216. In some embodiments, the electrode 300 is cut along a cut line CL to separate the discrete portions of the cathode coating layer 210. In some embodiments, trimming includes defining a tab 408 for the bi-polar current collector 206 (also referred to as notching). In some embodiments, a tab 408 is only formed for a topmost and/or bottommost bi-polar current collector 206 in a stack of a plurality of the electrodes 300 (not separately shown).

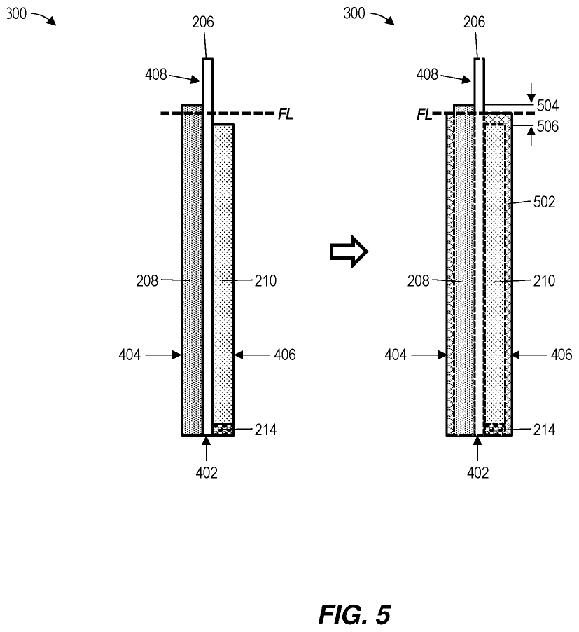

FIG. 5 illustrates an example view of the electrode 300 during a third portion of a roll-to-roll manufacturing process (not separately shown) in accordance with one or more embodiments. As shown in FIG. 5, an ion conducting gel electrolyte 502 is formed over the electrode 300. In some embodiments, the ion conducting gel electrolyte 502 is formed by wetting the electrode 300 with a liquid electrolyte precursor (not separately shown). While not meant to be particularly limited, the liquid electrolyte precursor can include, for example, a fluorinated phosphate flame retardant electrolyte, dimethyl methylphosphonate (DMMP), trimethyl phosphate (TMP), triethyl phosphate (TEP), tris(2,2,2-trifluoroethyl) phosphate (TFEP), combinations thereof, and may or may not include additives such as 1-diphenylphosphoryloxy-4-methylbenzene (DPMB) (e.g., at 2 wt. %).

In some embodiments, the liquid electrolyte precursor includes an organic solvent, a metal ion salt, a cross-linkable polymer, and a cross-linking initiator. In some embodiments, the liquid electrolyte precursor includes a phosphonate-functionalized ionic liquid (PFIL) as a multifunctional additive to a base liquid electrolyte precursor mixture including ethylene carbonate, dimethyl carbonate and lithium hexafluorophosphate (LiPF6). Notably, the addition of PFIL at 5 wt. % has been shown to improve cyclic stability and rate. In some embodiments, the liquid electrolyte precursor includes TEP and/or other phosphate type organic solvent(s) for stability.

In some embodiments, the organic solvent includes ethylene carbonate (EC) and/or dimethyl carbonate (DMC). In some embodiments, the organic solvent includes ethylene carbonate (EC). EC is a cyclic carbonate solvent that can be used in lithium-ion batteries. It has good solubility for lithium salts and helps form a stable solid electrolyte interface (SEI) layer on the electrode surfaces. In some embodiments, the organic solvent includes dimethyl carbonate (DMC). DMC is another cyclic carbonate solvent. It has a high dielectric constant and good solubility for lithium salts. DMC can be used in combination with other solvents to optimize the electrolyte properties. In some embodiments, the organic solvent includes diethyl carbonate (DEC). DEC is a cyclic carbonate solvent that is similar to DMC. It can be used in combination with other solvents to improve the overall performance of the electrolyte. In some embodiments, the organic solvent includes ethyl methyl carbonate (EMC). EMC is a linear carbonate solvent that can be used in lithium-ion battery electrolytes. It can improve the low-temperature performance of the battery.

In some embodiments, the metal ion salt includes a lithium salt such as, for example, LiPF6. Other salts are possible. In some embodiments, the metal ion salt includes lithium bis(trifluoromethanesulfonyl)imide (LiTFSI). In some embodiments, the metal ion salt includes lithium perchlorate (LiClO₄). In some embodiments, the metal ion salt includes lithium trifluoromethanesulfonate (LiCF₃SO₃). In some embodiments, the metal ion salt includes lithium borofluoride (LiBF₄). In some embodiments, the metal ion salt includes lithium bis(15xalate) borate (LiBOB). In some embodiments, the metal ion salt includes lithium bis(fluorosulfonyl)imide (LiFSI).

In some embodiments, the cross-linkable polymer includes, for example, polyethylene oxide (PEO) with terminal acrylate groups, acrylates, etc. In some embodiments, the cross-linking initiator includes, for example, an ultraviolet (UV) light and/or heat and/or chemical initiator. Such initiators can include benzoin methyl ether, acrylate-functionalized polymers, benzophenone (CAS No. 119-61-9), 2-hydroxy-2-methyl-1-phenylpropanone (CAS No. 7473-98-5), etc. Heat initiators include bis(4-tert-butylcyclohexyl) peroxydicarbonate (CAS No. 15520-11-3), t-Hexyl peroxy-2-ethyl hexanoate (CAS No. 137791-98-1) etc.

In some embodiments, the liquid electrolyte precursor is filled to a filling level FL between a topmost surface 504 of the anode coating layer 208 and a topmost surface 506 of the cathode coating layer 210. In other words, the liquid electrolyte precursor overhangs the cathode coating layer 210 but does not fully cover the anode coating layer 208. This also results in the liquid electrolyte precursor filling level FL being below the sheet-by-sheet ionic channel blocker 216 (refer to FIG. 4). In some embodiments, after filling (and following any soak time as desired), cross-linking can be initiated in a similar manner as for the non-ionic conducting gel described previously (e.g., UV exposure, heat exposure, etc.), except that the result is the formation of the ion conducting gel electrolyte 502.

There are at least two possible manufacturing schemes for integrating the formation of the ion conducting gel electrolyte 502 with the roll-to-roll manufacturing of the electrode 300. Each manufacturing scheme is addressed in turn.

In some embodiments, a number of intermediate bi-polar electrodes (each a cutout of the electrode 300, refer to FIG. 4) are assembled into a bi-polar stack (not separately shown) with separators made of poly-olefins (PE, PP, etc.) and/or ceramics using Z-folding methods and/or simple sheet stacking methods. The bi-polar stack can be packaged into a polymeric laminated pouch (also referred to as a laminated polymeric package).

The polymeric laminated pouch can be completely wetted using a liquid electrolyte precursor as described previously. In some embodiments, the liquid electrolyte precursor can be poured into the polymeric laminated pouch, the liquid electrolyte precursor is allowed to soak the polymeric laminated pouch (for any desired soak duration), the polymeric laminated pouch can be sealed, and the polymeric laminated pouch can be heated to initiate cross-linking. In some embodiments, the polymeric laminated pouch can be heated to a temperature of 60 degrees Celsius to convert the liquid electrolyte precursor to the ion conducting gel electrolyte 502.

Alternatively, in some embodiments, a number of intermediate bi-polar electrodes (each a cutout of the electrode 300, refer to FIG. 4) are assembled into a bi-polar stack (not separately shown) with separators made of poly-olefins (PE, PP, etc.) and/or ceramics using Z-folding methods and/or simple sheet stacking methods. In some embodiments, a pre-defined container is coated with chemically stable polymers (e.g., PP, PE, PTFT, PPS, etc.) and the bi-polar stack is placed in the container. In some embodiments, the bi-polar stack is compressed and/or the electrodes are pre-welded to maintain a height of the bi-polar stack in the container (that is, to prevent shift and/or to maintain electrode alignment). In some embodiments, the liquid electrolyte precursor can be poured into the pre-defined container and the liquid electrolyte precursor is allowed to soak for any desired soak duration. The pre-defined container can be sealed, and the pre-defined container can be heated to initiate cross-linking. In some embodiments, the pre-defined container can be heated to a temperature of 60 degrees Celsius to convert the liquid electrolyte precursor to the ion conducting gel electrolyte 502. After complete gelation of the ion conducting gel electrolyte 502, the bi-polar stack can be removed from the pre-defined container and the bi-polar stack can be trimmed to any desired dimension. For example, after liquid electrode cross-linking, the bi-polar electrode stack can be moved to a trimming station or module in which a folding separator as well as small amount of anode coating can be trimmed out to ensure complete separation of the metal ion channel(s) among the bi-polar electrodes.

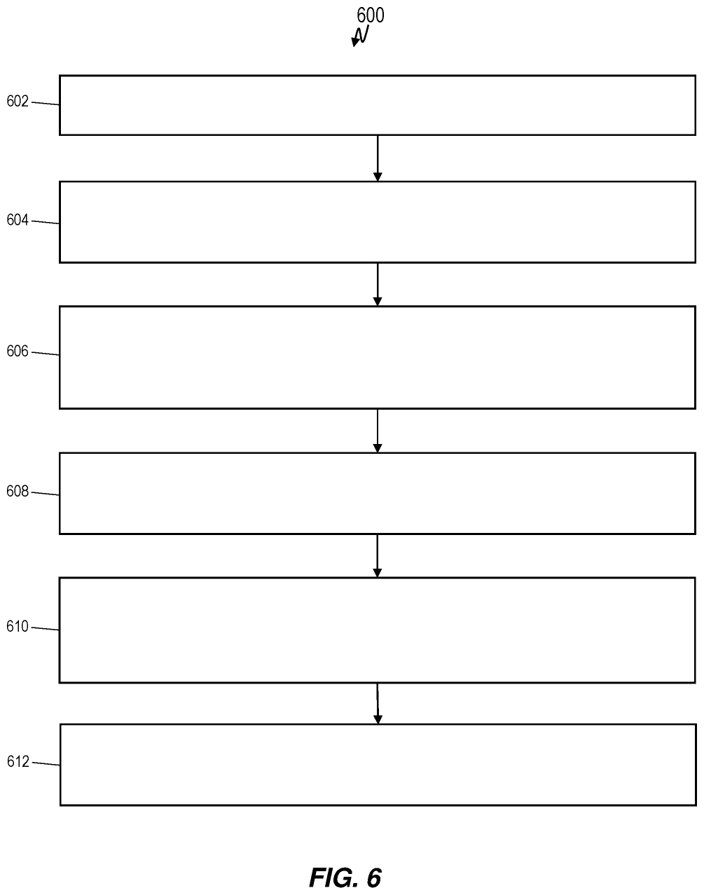

Referring now to FIG. 6, a flowchart 600 for manufacturing bi-polar electrodes is generally shown according to an embodiment. The flowchart 600 is described in reference to FIGS. 1-5 and may include additional steps not depicted in FIG. 6. Although depicted in a particular order, the blocks depicted in FIG. 6 can be rearranged, subdivided, and/or combined.

At block 602, the method includes providing a bi-polar current collector.

At block 604, the method includes forming an anode coating layer on a first surface of the bi-polar current collector.

At block 606, the method includes forming a cathode coating layer on a second surface of the bi-polar current collector. In some embodiments, the second surface of the bi-polar current collector is opposite the first surface of the bi-polar current collector.

At block 608, the method includes positioning a roll-to-roll ionic channel blocker (also referred to as a first ionic channel blocker) along a first edge of the bi-polar current collector. At block 610, the method includes positioning a sheet-by-sheet ionic channel blocker along a second edge and a third edge of the bi-polar current collector (also referred to as second and third ionic channel blockers, respectively). In some embodiments, the second edge and the third edge of the bi-polar current collector are orthogonal to the first edge.

In some embodiments, the metal ion channel blocker includes a non-ionic conducting gel having an infinite viscosity at zero shear rate.

In some embodiments, the non-ionic conducting gel is formed from a viscous solution that includes an organic solvent and a gelation polymer mixture that includes a cross-linkable polymer, a rheological modifier, and a cross-linking initiator.

In some embodiments, the organic solvent includes a non-flammable organic solvent such as triethyl phosphate.

In some embodiments, the metal ion channel blocker is formed in-situ and includes a polyimide or polyimide blended with polyvinylidene difluoride (PVdF) polymer.

At block 612, the method includes forming an ionic conducting gel electrolyte over the anode coating layer and the cathode coating layer. In some embodiments, the ionic conducting gel electrolyte is formed from a liquid electrolyte precursor that includes an organic solvent, a metal ion salt, a cross-linkable polymer, and a cross-linking initiator.

In some embodiments, the ionic conducting gel electrolyte is filled over the battery cell to a filling level that is between a topmost surface of the anode coating layer and a topmost surface of the cathode coating layer.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
an electric motor; and
a battery pack electrically coupled to the electric motor, the battery pack comprising a battery cell, the battery cell comprising:
a bi-polar current collector;
an anode coating layer formed on a first surface of the bi-polar current collector;
a cathode coating layer formed on a second surface of the bi-polar current collector, the second surface of the bi-polar current collector opposite the first surface of the bi-polar current collector;
a roll-to-roll ionic channel blocker positioned along a first edge of the bi-polar current collector;
a sheet-by-sheet ionic channel blocker positioned along a second edge and a third edge of the bi-polar current collector, the second edge and the third edge of the bi-polar current collector orthogonal to the first edge; and
an ionic conducting gel electrolyte formed over the anode coating layer and the cathode coating layer.

2. The vehicle of claim 1, wherein the roll-to-roll ionic channel blocker and the sheet-by-sheet ionic channel blocker include a metal ion channel blocker.

3. The vehicle of claim 2, wherein the metal ion channel blocker includes a non-ionic conducting gel having an infinite viscosity at zero shear rate.

4. The vehicle of claim 3, wherein the non-ionic conducting gel is formed from a viscous solution that includes an organic solvent and a gelation polymer mixture that includes a cross-linkable polymer, a rheological modifier, and a cross-linking initiator.

5. The vehicle of claim 2, wherein the metal ion channel blocker is formed in-situ and comprises a polyimide or polyimide blended with polyvinylidene difluoride (PVdF) polymer.

6. The vehicle of claim 1, wherein the ionic conducting gel electrolyte is formed from a liquid electrolyte precursor that includes an organic solvent, a metal ion salt, a cross-linkable polymer, and a cross-linking initiator.

7. The vehicle of claim 1, wherein the ionic conducting gel electrolyte is filled over the battery cell to a filling level that is between a topmost surface of the anode coating layer and a topmost surface of the cathode coating layer.

8. A battery cell comprising:
a bi-polar current collector;
an anode coating layer formed on a first surface of the bi-polar current collector;
a cathode coating layer formed on a second surface of the bi-polar current collector, the second surface of the bi-polar current collector opposite the first surface of the bi-polar current collector;
a first ionic channel blocker positioned along a first edge of the bi-polar current collector;
a second ionic channel blocker positioned along a second edge of the bi-polar current collector and a third ionic channel blocker positioned along a third edge of the bi-polar current collector, the second edge and the third edge of the bi-polar current collector orthogonal to the first edge; and
an ionic conducting gel electrolyte formed over the anode coating layer and the cathode coating layer.

9. The battery cell of claim 8, wherein the first ionic channel blocker, the second ionic channel blocker, and the third ionic channel blocker each include a metal ion channel blocker, and wherein the metal ion channel blocker includes a non-ionic conducting gel having an infinite viscosity at zero shear rate.

10. The battery cell of claim 9, wherein the non-ionic conducting gel is formed from a viscous solution that includes an organic solvent and a gelation polymer mixture that includes a cross-linkable polymer, a rheological modifier, and a cross-linking initiator.

11. The battery cell of claim 10, wherein the organic solvent comprises a non-flammable organic solvent comprising triethyl phosphate.

12. The battery cell of claim 9, wherein the metal ion channel blocker is formed in-situ and comprises a polyimide or polyimide blended with polyvinylidene difluoride (PVdF) polymer.

13. The battery cell of claim 8, wherein the ionic conducting gel electrolyte is formed from a liquid electrolyte precursor that includes an organic solvent, a metal ion salt, a cross-linkable polymer, and a cross-linking initiator.

14. The battery cell of claim 8, wherein the ionic conducting gel electrolyte is filled over the battery cell to a filling level that is between a topmost surface of the anode coating layer and a topmost surface of the cathode coating layer.

15. A method comprising:
providing a bi-polar current collector;
forming an anode coating layer on a first surface of the bi-polar current collector;
forming a cathode coating layer on a second surface of the bi-polar current collector, the second surface of the bi-polar current collector opposite the first surface of the bi-polar current collector;
positioning a roll-to-roll ionic channel blocker along a first edge of the bi-polar current collector;
positioning a sheet-by-sheet ionic channel blocker along a second edge and a third edge of the bi-polar current collector, the second edge and the third edge of the bi-polar current collector orthogonal to the first edge; and
forming an ionic conducting gel electrolyte over the anode coating layer and the cathode coating layer.

16. The method of claim 15, wherein the roll-to-roll ionic channel blocker and the sheet-by-sheet ionic channel blocker include a metal ion channel blocker, and wherein the metal ion channel blocker includes a non-ionic conducting gel having an infinite viscosity at zero shear rate.

17. The method of claim 16, wherein the non-ionic conducting gel is formed from a viscous solution that includes an organic solvent and a gelation polymer mixture that includes a cross-linkable polymer, a rheological modifier, and a cross-linking initiator.

18. The method of claim 17, wherein the organic solvent comprises a non-flammable organic solvent comprising triethyl phosphate.

19. The method of claim 15, wherein the ionic conducting gel electrolyte is formed from a liquid electrolyte precursor that includes an organic solvent, a metal ion salt, a cross-linkable polymer, and a cross-linking initiator.

20. The method of claim 15, wherein the ionic conducting gel electrolyte is filled over a battery cell to a filling level that is between a topmost surface of the anode coating layer and a topmost surface of the cathode coating layer.
